(19) United States
(12) Patent Application Publication
(10) Pub. No.: US 2005/0186552 A1
(43) Pub. Date: Aug. 25, 2005

(54) Board for drawing and writing

(76) Inventor: Deborah Finneran, Morgan, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/104,153

(22) Filed: Apr. 12, 2005

Related U.S. Application Data
(63) Continuation of application No. 09/718,016, filed on Nov. 21, 2000.

(51) Int. Cl. C09D 13/00; B43L 1/00

(52) U.S. Cl. 434/408

(57) ABSTRACT

A surface of laser-cut acrylic. The surface can be any shape that is capable of being created from a plane but is preferably planar. Lines are placed upon such a surface with one or more coloring crayons and have a glowing appearance under either natural or artificial illumination. An aperture is optionally placed in the surface to facilitate manipulation of such surface or the connection of other objects to such surface. A container holding one or more coloring crayons can be attached to the surface. And the invention contemplates marketing a combination of the surface, one or more coloring crayons, and a wipe.

### CROSS-REFERENCE TO RELATED APPLICATIONS

This application is a continuation of U.S. patent application Ser. No. 09/718,016, filed Nov. 21, 2000 and entitled BOARD FOR DRAWING AND WRITING, which is incorporated by reference in its entirety.

### BACKGROUND OF THE INVENTION

1. Field of the Invention

This invention relates to a board for providing a unique glowing appearance when lines are placed upon the board with a coloring crayon.

2. Related Technology

Clip boards exist which are made of laser-cut acrylic. The inventor is, however, unaware of laser-cut acrylic being constructed or used for writing or drawing on the board, itself, or of such a clip board having other than a planar shape.

The inventor is also unaware of any prior marketing of combined laser-cut acrylic board, coloring crayon or crayons, and a wipe.

### BRIEF SUMMARY OF THE INVENTION

A line placed upon a laser-cut acrylic board with a crayon has, under either natural or artificial illumination, a glowing appearance. To the best of the Inventor's knowledge, no one else has recognized that such a surprising, unique visual effect can be so attained.

The present invention, thus, comprises a laser-cut acrylic board upon which one or more lines have been placed with a coloring crayon.

Also, the invention covers a laser-cut acrylic board having an aperture to accommodate one or more digits of a hand to facilitate moving the board or connecting other objects.

Such other objects include a container for holding one or more coloring crayons and a wipe, such as a cloth, to remove lines placed upon the board by a crayon.

This invention also contemplates marketing a combined laser-cut acrylic board, coloring crayon or crayons, and a wipe as well as the process of placing a line on a laser-cut acrylic board with a coloring crayon.

### BRIEF DESCRIPTION OF THE DRAWINGS

FIG. 1 depicts the laser-cut acrylic board having a line from a coloring crayon.

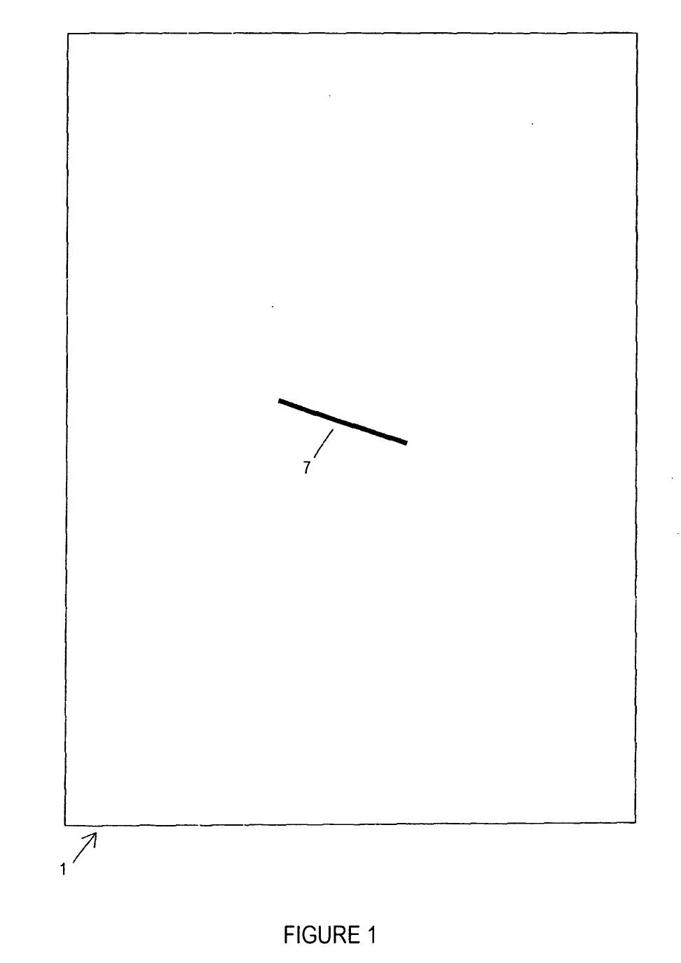

FIG. 2 illustrates the laser-cut acrylic board having an aperture to accommodate one or more digits of a hand and being connected to a bag holding a coloring crayon and a wipe.

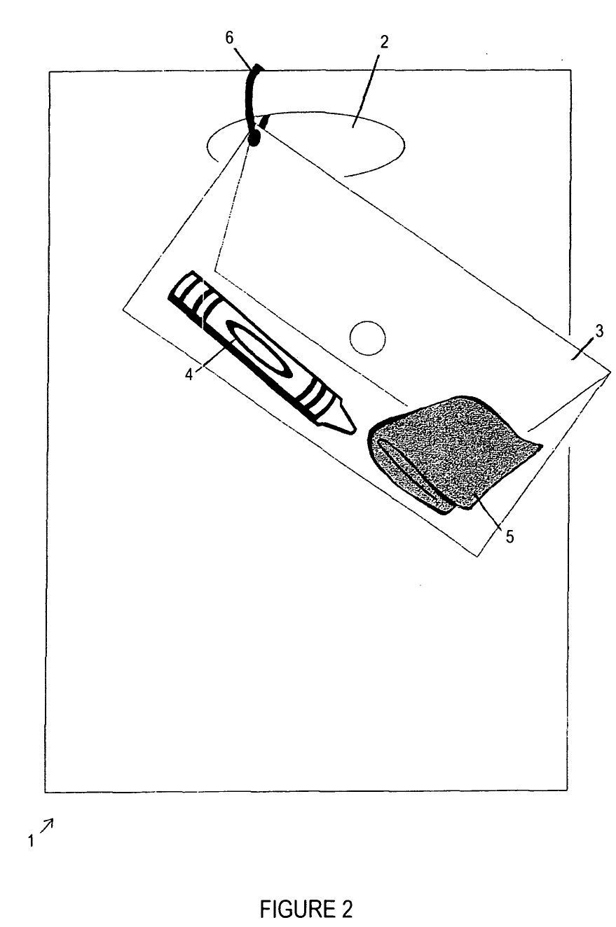

### DETAILED DESCRIPTION OF THE PREFERRED EMBODIMENTS

The Board for Drawing and Writing is formed from a surface 1, which is preferably planar but can be any shape that is capable of being created by folding a plane, of laser-cut acrylic. Without limitation and merely as examples, such shapes include spheres and polyhedrons.

Preferably, an aperture 2 exists in the surface 1 for accommodating one or more digits of a hand to facilitate moving the surface 1 or connecting other objects. And, also preferably, a container 3, preferably a bag, for holding one or more coloring crayons 4 and a wipe 5 is attached to the surface 1, preferably with a strap 6 passing through the aperture 2.

One or more lines 7 are placed upon the surface 2 with a coloring crayon 4. Preferably, the color of such lines 7 is white, although even an essentially transparent or translucent coating of material from a coloring crayon will, for the purposes of this invention, be considered to have a color, which would be termed “transparent” or “translucent.” Any color for the coloring crayon 4 is, however, satisfactory.

And marketing, by offering to sell or selling or both, a combined surface 1 made of laser-cut acrylic, one or more coloring crayons 4, and a wipe 5 is also intended.

1. A board for drawing and writing, which comprises:
a surface of laser-cut acrylic.

2. The board for drawing and writing as recited in claim 1, wherein said surface contains an aperture.

3. The board for drawing and writing as recited in claim 2, further comprising a container for holding one or more coloring crayons and a wipe, said container being attached to said surface.

4. The board for drawing and writing as recited in claim 3, further comprising one or more coloring crayons and a wipe within said container.

5. The board for drawing and writing as recited in claim 3, further comprising one or more lines having a color placed upon said surface with a coloring crayon.

6. The board for drawing and writing as recited in claim 5, further comprising one or more coloring crayons and a wipe within said container.

7. The board for drawing and writing as recited in claim 6, wherein the color of said lines is white.

8. The board for drawing and writing as recited in claim 5, wherein the color of said lines is white.

9. The board for drawing and writing as recited in claim 2, further comprising one or more lines having a color placed upon said surface with a coloring crayon.

10. The board for drawing and writing as recited in claim 9, wherein the color of said lines is white.

11. The board for drawing and writing as recited in claim 1, further comprising a container for holding one or more coloring crayons and a wipe, said container being attached to said surface.

12. The board for drawing and writing as recited in claim 11, further comprising one or more coloring crayons and a wipe within said container.

13. The board for drawing and writing as recited in claim 11, further comprising one or more lines having a color placed upon said surface with a coloring crayon.

14. The board for drawing and writing as recited in claim 13, further comprising one or more coloring crayons and a wipe within said container.

15. The board for drawing and writing as recited in claim 14, wherein the color of said lines is white.

16. The board for drawing and writing as recited in claim 1, further comprising one or more lines having a color placed upon said surface with a coloring crayon.

17. A system for drawing and writing comprising:
an acrylic board including at least one laser-cut surface;
a writing instrument, at least a portion of the writing instrument configured to leave a removable residue upon the acrylic board;
wherein the at least one laser-cut surface, when under illumination, causes the removable residue to glow.

18. The system for drawing and writing as recited in claim 17, wherein the writing instrument comprises a crayon.

19. A method for drawing and writing comprising:
providing an acrylic structure including at least one marking surface and at least one laser-cut portion;
providing a writing instrument;
using the writing instrument to leave at least one mark upon the at least one marking surface of the acrylic structure, the at least one mark comprising a removable residue;
wherein the at least one laser-cut portion, when under illumination, causes the removable residue to glow.

20. The method for drawing and writing as recited in claim 19, wherein the acrylic structure comprises a generally planar board and wherein the at least one marking surface comprises a generally planar marking surface.
